(19) United States
(12) Patent Application Publication
(10) Pub. No.: US 2026/0016027 A1
(43) Pub. Date: Jan. 15, 2026

(54) SYSTEM USING A CENTRAL AIR SOURCE TO DRIVE A PASSENGER CAR AIR MOTOR

(71) Applicant: Mastery Investment LLC, Kowloon KLN (HK)

(72) Inventors: Jianjun Tan, Kowloon KLN (HK); Daisy Lina Kwok, Kowloon KLN (HK)

(21) Appl. No.: 19/269,621

(22) Filed: Jul. 15, 2025

Related U.S. Application Data
(60) Provisional application No. 63/671,593, filed on Jul. 15, 2024.

(51) Int. Cl. F15B 15/18; B60R 16/08; B60S 1/10; F15B 13/04

(52) U.S. Cl. CPC F15B 15/18; B60R 16/08; F15B 13/0401; B60S 1/10

(57) ABSTRACT

The present disclosure provides a system using a central air source to drive a passenger car air motor, which comprises an air compressor, an air tank and an air consumption module. The air compressor is respectively in pneumatic communication with the air tank and the air consumption module through a distribution valve group and supplies air to them. The distribution valves are in pneumatic communication with several air motors, which are used to drive the on-board execution module to work. The present disclosure replaces the power source used to drive the actuator from common electric motor with an air motor, and uses the on-board air supply unit to supply air to the air motor.

### PRIORITY CLAIM

This application claims the benefit of and priority to U.S. Provisional Patent App. No. 63/671,593, titled “SYSTEM USING A CENTRAL AIR SOURCE TO DRIVE A PASSENGER CAR AIR MOTOR”, filed Jul. 15, 2024, the contents of which are hereby incorporated by reference in their entirety.

### TECHNICAL FIELD

The disclosure relates to the technical field of air systems for passenger vehicles, and specifically to a system using a central air source to drive a passenger car air motor.

### BACKGROUND

With the improvement of people's living standards, the executive agents equipped to vehicles are more and more abundant. An executive agent (which may also be referred to as an actuator, actuating mechanism, or executive mechanism), as used herein, refers to a vehicle feature that has at least one varying physical characteristic. Some examples include window lifting mechanisms, trunk lifting mechanisms, and seat lifting mechanisms. The conventional power source of the actuators for these executive mechanisms is mostly motors. However, the use of motors, taken as a given for most manufacturers, imports its own set of limitations. On the one hand, the number of motors increases the cost of vehicles. Moreover, electric motors usually need to be equipped with complex electronic control systems, have a more complex structure, are heavier, and have higher maintenance costs in the later part of their life cycles. On the other hand, the air supply units of the vehicle-mounted air suspension system, such as air compressors and air tanks, have limited usage frequency and their functions are difficult to be fully exerted. Therefore, the present disclosure is intended to provide an air motor system that addresses these deficiencies in the conventional art.

### SUMMARY

To this end, the present disclosure provides a system using a central air source to drive a passenger car air motor to solve the above defects in the prior art. The disclosure provides a system that in some embodiments combines the vehicle air unit and reduces the operating cost of each actuator.

The present disclosure therefore also provides a method where an existing set of on-board air supply units can be utilized to supply air to multiple sets of air motors, replacing the existing electric motors to drive the operation of multiple on-board actuators. It should be understood that the system and its operation method presented in this article are not limited to passenger vehicles, but can be applied to any system that utilized air compressors and air motors.

In a first aspect, which may be combined with any other aspect herein unless otherwise noted, a vehicle system includes using a central air source to drive a passenger car air motor, and the vehicle system comprises an air compressor, an air tank, and an air usage module. The air compressor is respectively in pneumatic communication with each of the air tank and the air module through a first distribution valve group, the high-pressure air generated by the operation of the air compressor can be delivered to the air usage module and the air tank through the first distribution valve group. The first distribution valve group is in pneumatic communication with a plurality of air motors, and the plurality of air motors are used to drive an on-board execution module to work. Compressed air is able to be conveyed from the air tank or the air compressor to the air motor through the first distribution valve group.

In a second aspect, which may be combined with any other aspect herein unless otherwise noted, the system further comprises a pressure regulating valve, and air regulated by the pressure regulating valve is introduced into the corresponding air motor to achieve the regulation of the rotational speed and torque of the air motor, and the pressure regulating valve is connected to the air tank or the air compressor airway.

In a third aspect of the present disclosure, which may be combined with any other aspect herein unless otherwise noted, the system further comprises a controller, and the controller is in operable communication with the first distribution valve group, the air compressor, the pressure regulating valve, and the execution module.

In a fourth aspect of the present disclosure, which may be combined with any other aspect herein unless otherwise noted, the execution module comprises a manual execution unit, and the manual execution unit comprises at least one first executive mechanism, each of which is in pneumatic communication with an air motor and in operable communication with a control button, and the control button is in operable communication with the controller.

In a fifth aspect of the present disclosure, which may be combined with any other aspect herein unless otherwise noted, the execution module comprises an automatic execution unit, and the automatic execution unit comprises at least one second executive mechanism, each of which is respectively in pneumatic communication with an air motor and in operable communication with a sensor, and the sensor is in operable communication with the controller.

In a sixth aspect of the present disclosure, which may be combined with any other aspect herein unless otherwise noted, the system comprises a total of one pressure regulating valve, the first distribution valve group is in pneumatic communication with the pressure regulating valve and the second distribution valve group. The air regulated by the pressure regulating valve is in pneumatic communication with several air motors through the second distribution valve group. The second distribution valve group is in operable communication with the controller.

In a seventh aspect of the present disclosure, which may be combined with any other aspect herein unless otherwise noted, the system comprises a plurality of pressure regulating valves, each air motor is equipped with a pressure regulating valve to regulate the intake air pressure, and several of the pressure regulating valves are all connected to the first distribution valve group airway.

In an eighth aspect of the present disclosure, which may be combined with any other aspect herein unless otherwise noted, the execution module may include (but is not limited to) a seat adjustment mechanism, a window lifting mechanism, a sunroof opening and closing system, a trunk/tailgate opening and closing mechanism, a wiper mechanism, an air conditioning damper control and a door lock mechanism.

In a ninth aspect of the present disclosure, which may be combined with any other aspect herein unless otherwise noted, the motor driving the compressed air of the air compressor is a brushless motor With stepless frequency conversion control function.

In a tenth aspect of the present disclosure, which may be combined with any other aspect herein unless otherwise noted, the usage module is an air spring.

In an eleventh aspect of the present disclosure, which may be combined with any other aspect herein unless otherwise noted, a central air source for a vehicle system is provided, the central air source comprising an air compressor, an air tank, and an air module. The central air source is configured to provide pressurized air to at least one actuator of the vehicle, and the air compressor is in operable communication with a controller, and wherein actuation of each of the at least one actuator is controlled by a control button, which control button is in operable communication with the controller.

In a twelfth aspect of the present disclosure, which may be combined with any other aspect herein unless otherwise noted, the at least one actuator comprises at least one of a window lifting mechanism, a trunk opening mechanism, a trunk closing mechanism, a seat adjustment mechanism, and a wiper mechanism.

In a thirteenth aspect of the present disclosure, which may be combined with any other aspect herein unless otherwise noted, the central air source is configured to provide pressurized air to the at least one actuator by air compressed by the air compressor.

In a fourteenth aspect of the present disclosure, which may be combined with any other aspect herein unless otherwise noted, the central air source is configured to provide pressurized air to the at least one actuator by compressed air stored in the air tank.

In a fifteenth aspect of the present disclosure, which may be combined with any other aspect herein unless otherwise noted, at least one pressure regulating valve is in pneumatic communication and disposed between the central air source and the at least one actuator.

In a sixteenth aspect of the present disclosure, which may be combined with any other aspect herein unless otherwise noted, the at least one actuator comprises a plurality of actuators.

In a seventeenth aspect of the present disclosure, which may be combined with any other aspect herein unless otherwise noted, the at least one pressure regulating valve comprises a plurality of pressure regulating valves, and wherein each of the plurality of pressure regulating valves corresponds to one of the plurality of actuators.

In an eighteenth aspect of the present disclosure, which may be combined with any other aspect herein unless otherwise noted, wherein an air motor is in pneumatic communication with and disposed between each of the at least one actuator and each of the at least one pressure regulating valve.

In a nineteenth aspect of the present disclosure, which may be combined with any other aspect herein unless otherwise noted, wherein a motor used by the air compressor is a brushless motor.

In a twentieth aspect of the present disclosure, which may be combined with any other aspect herein unless otherwise noted, wherein a motor used by the air compressor has a stepless frequency conversion control function.

The disclosure provides the following example advantages:
(1) The disclosed systems, apparatus, and methods replace the power source used to drive the operation of the actuation unit with an air motor, and uses the on-board air supply unit air compressor and air tank to supply air to the air motor. On the one hand, compared with an electric motor, the air motor can be controlled by a simple flow control valve to achieve system control, without the need to be equipped with a complex electronic control system, and the structure is simpler. The subsequent maintenance cost is lower, and the purchase cost is also lower compared to electric motors. I can effectively reduce the cost of the operation of the execution unit and is more conducive to the demand for vehicle lightweighting. On the other hand, multiple actuators can share one air supply unit, which can increase the utilization rate of the air supply unit and reduce the operating cost of the entire system;
(2) The air motor system of the present disclosure has strong applicability and can meet the operation requirements of most manual and automatic actuation units on vehicles.

Additional features and advantages of the disclosed system, method, and apparatus are described in, and are apparent from, the following Detailed Description and the Figures.

### BRIEF DESCRIPTION OF THE FIGURES

The accompanying drawings, which are incorporated in and constitute a part of this specification, show certain aspects of the subject matter disclosed herein and, together with the description, help explain some of the principles associated with the disclosed implementations.

FIG. 1 is a schematic diagram of an example embodiment of the present disclosure.

FIG. 2 is a schematic diagram of another example embodiment of the present disclosure.

### DETAILED DESCRIPTION

The following non-limiting designations are used in the figures:
1—Air compressor;
2—Air tank;
3—Air usage module;
4—First distribution valve group;
5—Air motor;
6—Controller;
7—Control button(s);
8—Sensor;
9—Pressure regulating valve;
10—Second distribution valve group;
11—First executive mechanism (or actuator);
12—Second executive mechanism (or actuator);
100—Execution (or actuation) module;
200—Manual execution (or actuation) unit;
300—Automatic execution (or actuation) unit.

In order to make the technical means, creative features, objectives and effects of the present disclosure easy to understand, the following further elaborates in combination with specific example implementation modes of the disclosed systems, apparatus, and methods.

In the existing technology, passenger vehicles are equipped with several actuating mechanisms, such as the common window lift mechanism, trunk opening and closing mechanism, seat lift mechanism, etc. The power sources of these actuators are mostly electric motors. On the one hand, the large number of electric motors increases the purchase cost. Moreover, electric motors usually need to be equipped with complex electronic control systems, have a more complex structure, are heavier, and have higher maintenance costs in the later stage. On the other hand, the on-board air supply units such as air compressors have limited usage frequency and their functions are difficult to be fully exerted.

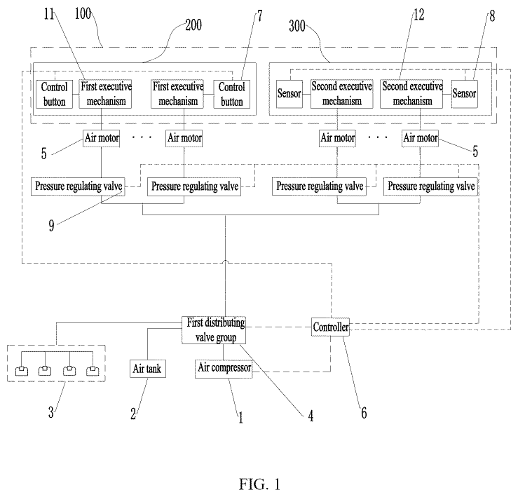

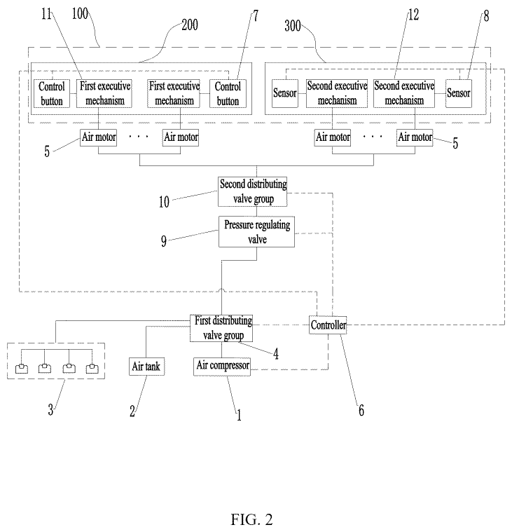

For this purpose, as shown in FIGS. 1 and 2, the present disclosure provides an air motor system for passenger vehicles. The existing set of on-board air supply units can be utilized to supply air to multiple sets of air motors, replacing the existing electric motors to drive the operation of multiple on-board actuators.

In some embodiments of the present disclosure, the air motor system comprises an air compressor 1, an air tank 2 and an air usage module 3. The air compressor 1, the air usage module 3 and the air tank 2 are all in pneumatic communication with a first distribution valve group 4. The high-pressure air generated by the operation of the air compressor 1 can be delivered to the air usage module 3 and the air tank 2 through the first distribution valve group 4. Air compressor 1 and air tank 2 are common air supply units.

In some embodiments of the present disclosure, the air usage module 3 may be an air spring. The air compressor 1 generates compressed air, and the compressed air is discharged to the air tank 2 for storage, or discharged into the air spring to adjust the ground clearance of the chassis, thereby increasing the stability of the high-speed vehicle body or improving the operation in complex road conditions.

In some other embodiments (not shown in the figures), the air usage module 3 may also be other air-consuming modules that can be used in conjunction with air compressor 1, such as automotive seat massage systems, seat side wing support systems, etc.

In some embodiments of the present disclosure, the motor used in air compressor 1 is a brushless motor. The motor used has the function of stepless frequency conversion control. Brushless motors have the advantages of high efficiency, low energy consumption, low noise, long service life, high reliability, servo control, stepless speed regulation, relatively low cost and easy use compared with brushed DC motors.

In some embodiments of the present disclosure, the first distribution valve group 4 is configured to distribute the high-pressure air compressed by the air compressor 1. The distributed air can be used in the corresponding air usage module 3 or stored in the air tank 2.

In some embodiments of the present disclosure, the air distributed by the first distribution valve group 4 can also be used as the power source to drive the air motor 5 to work.

In some embodiments of the present disclosure, the first distribution valve group 4 is in pneumatic communication with several air motors 5, that is, the compressed air in the air compressor 1 and the air tank 2 can be used to drive the air motor 5 to achieve forward and reverse rotation. The air motor 5 is used to drive the on-board execution module 100 to work. The first distribution valve group 4 is configured to convey compressed air from the air tank 2 or the air compressor 1 to the air motor 5.

Embodiments of the present disclosure replace the power source used to drive the existing on-board execution module 100 from the original electric motor with an air motor 5, and use a set of existing air supply units of passenger vehicles to inflate the air motor 5. On the one hand, compared with electric motors, air motors can achieve system control using simple flow control valves, without the need for complex electronic control systems. Their structure is simpler, and the subsequent maintenance costs are lower. The purchase cost is also lower than that of electric motors, which can effectively reduce the cost of operating the execution unit and is more conducive to the demand for vehicle lightweighting. On the other hand, multiple actuating mechanisms can share one air supply unit, thereby enhancing the utilization rate of the air supply units.

The execution module 100 may include but not be limited to seat adjustment mechanisms (such as forward and backward movement of the seat, backrest tilting, height adjustment, etc.), window lifting mechanisms, sunroof opening and closing systems, trunk/tailgate opening and closing mechanisms, wiper mechanisms, air conditioning damper control, and door lock mechanisms.

In some embodiments, the execution module 100 includes a manual execution unit 200 and an automatic execution unit 300. This air motor system for passenger vehicles can meet the operational requirements of most manual and automatic actuator units on board, and has strong applicability.

Manual execution unit 200 in some embodiments requires manual intervention to control the operation of equipment or systems through manual operation. It relies on simple mechanical devices such as switches, buttons or knobs. It is suitable for occasions where the requirements for operational accuracy are not high and the operation frequency is relatively low. The manual execution unit 200 generally has a simple structure and a relatively low cost.

In some embodiments of the present disclosure, the manual actuator 200 comprises at least one first executive mechanism 11, each of which is respectively into an air pneumatic communication with the motor 5 and in operable communication with a control button 7.

For example, the first executive mechanism 11 may be a window lifting mechanism or a trunk opening and closing mechanism, and depending on specific usage requirements, it is not limited to these enumerated examples.

The automatic execution unit 300 in some embodiments does not require manual intervention and automatically controls the operation of equipment or systems through preset programs or sensors. It relies on electronic control systems, including sensors, controllers and actuators, etc. It is suitable for occasions with high requirements for operational accuracy and high operation frequency, or in dangerous and harsh environments.

In some embodiments of the present disclosure, the automatic execution unit 300 comprises at least one second executive mechanism 12, each of which is respectively in pneumatic communication with an air motor 5 and in operable communication with a sensor 8.

For example, the second executive mechanism 12 includes but is not limited to the seat adjustment mechanism and the wiper mechanism. The sensor 8 that cooperates with the second executive mechanism 12 can adopt different types according to specific circumstances. The sensors that cooperate with the seat adjustment mechanism can be pressure sensors, distance sensors and angle sensors, and the sensors that cooperate with the wiper mechanism can be rain gauges.

Meanwhile, in some embodiments of the present disclosure, the passenger car air motor system also includes a controller 6, which is electrically connected to and in operable communication with the first distribution valve group 4, the air compressor 1, the air motor 5 and the execution module 100.

Both the manual execution unit 200 and the automatic execution unit 300 are in operable communication with the controller 6, and both the control button 7 and the sensor 8 in the above embodiments are also in operable communication with the controller 6.

The controller 6 is used to receive instructions or signals from the control button 7 or the sensor 8, and to control the air supply unit and the first distribution valve group 4 to supply air to the corresponding air motor 5, thereby driving the air motor 5 to work and promoting the operation of the corresponding actuator.

In some embodiments of the present disclosure, air motor 5 achieves system control by using a flow control valve, so the control of air motors is simpler than that of electric motors. The air motor system includes a pressure regulating valve 9. The air regulated by the pressure regulating valve 9 is introduced into the corresponding air motor 5 to achieve the regulation of the rotational speed and torque of the air motor 5. The pressure regulating valve 9 is in pneumatic communication with the air tank 2 or the air compressor 1 airway.

In one embodiment of the present disclosure, as shown in FIG. 1, the first distribution valve group 4 is in pneumatic communication with several pressure regulating valves 9, and several of the pressure regulating valves 9 are in pneumatic communication with the air motor 5, and the pressure regulating valves 9 correspond one-to-one with the air motor 5. The air regulated by the corresponding pressure regulating valves 9 enters the air motor 5, and by adjusting the pressure regulating valves 9, the air source pressure supplied to the air motor 5 can be controlled, thereby influencing the rotational speed, torque and power of the air motor 5 to meet the operational requirements of the corresponding actuator. Further, all the pressure regulating valves 9 are in operable communication with the controller 6.

The forward and reverse rotation of an air motor can be achieved by controlling the direction of air intake. In the existing technology, most air motors can achieve the forward and reverse rotation of the output shaft of the air motor simply by using the control valve to change the intake and exhaust directions of the motor, and can also change direction instantaneously.

Taking the operation of a first executive mechanism 11 in the system of the present disclosure as an example, when the manual actuator unit 200 of the disclosed embodiments needs to work, the control button 7 corresponding to the first executive mechanism 11 is turned on, such as pressing the window button of the window lifting mechanism. Control button 7 feeds the information back to the controller 6. Or, taking the operation of a second executive mechanism 12 in the system of the present disclosure as an example, when sensor 8 collects signals, such as when a rain sensor senses the amount of rainfall, sensor 8 transmits the signal to the controller 6.

The signal is transmitted by the controller 6 to the air compressor 1, the first distribution valve group 4 and the corresponding pressure regulating valve 9 of the branch. This enables the air in the air compressor 1 or the air tank 2 to pass through the first distribution valve group 4 and be pressurized by the corresponding pressure regulating valve 9 before being supplied to the corresponding air motor 5. The air motor 5 operates to drive the corresponding first executive mechanism 11 to work, corresponding to the window lifting mechanism in the above embodiment to achieve the window lifting function or drive the corresponding second executive mechanism 12 to operate, corresponding to the wiper mechanism in the above embodiment, to scrape off the rainwater on the car window glass.

In another embodiment of the present disclosure, as shown in FIG. 2, the number of pressure regulating valves 9 is one, and the first distribution valve group 4 is successively in pneumatic communication with the pressure regulating valve 9 and the second distribution valve group 10. The air regulated by the pressure regulating valve 9 is in pneumatic communication with several air motors 5 through the second distribution valve group 10. The pressure regulating valve 9 and the second distribution valve group 10 are both in operable communication with the controller 6. Compared with the above embodiments, the number of pressure regulating valves 9 used in this embodiment is reduced, and costs are saved.

For example, when the automatic execution unit 300 of the present disclosure needs to work, the sensor 8 corresponding to the second executive mechanism 12 transmits data to the controller 6. For instance, when it rains, the rain gauge sensor corresponding to the wiper mechanism senses the rain situation (e.g. the amount of rain on the windshield) and transmits the data to the controller 6. The controller 6 transmits signals to the air compressor 1, the first distribution valve group 4, the second distribution valve group 10 and the pressure regulating valve 9. This enables the air in the air compressor 1 or the air tank 2 to pass through the first distribution valve group 4 and be regulated by the pressure regulating valve 9, and then be delivered respectively to the air motors 5 corresponding to each operating actuator through the second distribution valve group 10. The air motors 5 operate to drive the corresponding second executive mechanism 12 to work. That is, in this embodiment, the corresponding wiper performs a corresponding amplitude of windshield wiper operation according to the amount of rainfall.

In summary, embodiments of the present disclosure replace the power source used to drive the actuator from the common electric motor with an air motor, and use the on-board air supply unit air compressor and air tank to supply air to the air motor. On the one hand, compared with the electric motor, the air motor can achieve system control by using a simple flow control valve, without the need to be equipped with a complex electronic control system. The structure is simpler, the subsequent maintenance cost is lower, and the purchase cost is also lower compared to electric motors. On the other hand, multiple actuating mechanisms can share a single air supply unit, which enhances the utilization rate of the air supply unit, effectively reduces the cost of operating the actuating unit, and is more conducive to the demand for vehicle lightweighting.

Moreover, the air motor system of the present disclosure has strong applicability and can meet the operation requirements of most manual and automatic actuator units on vehicles.

Although the present systems, apparatus, and methods have been described in detail with general descriptions and specific embodiments in the previous text, it should be appreciated by those skilled in the art that some modifications or improvements can be made to these on the basis of the present disclosure. Therefore, all these modifications or improvements made without deviating from the spirit of the present disclosure fall within the scope of protection claimed.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. As one example, reference is made throughout to “solenoid valves”. It should be understood that a solenoid valve may be replaced with any electromechanical valve or other valve capable of carrying out the claimed systems, methods, or apparatus capabilities.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of these terms also does not exclude the possibility of other unrecited features or elements and is merely meant to be illustrative, unless otherwise implicitly or explicitly contradicted by the context in which it used.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above.

The invention is claimed as follows:

1. A system using a central air source to drive a passenger car air motor comprising:
an air compressor;
an air tank; and
an air usage module,
wherein the air compressor is in pneumatic communication with each of the air tank and the air usage module, and the air compressor, the air usage module, and the air tank are all in pneumatic communication with a first distribution valve group,
wherein the first distribution valve group is configured to deliver high pressure air generated by the operation of the air compressor to the air usage module and the air tank, and
wherein the first distribution valve group is in pneumatic communication with a plurality of air motors, wherein the plurality of air motors is used to drive an on-board execution module to work, and the first distribution valve group is configured to convey compressed air from the air tank or the air compressor to the air motor.

2. The system according to claim 1, wherein the system further comprises a pressure regulating valve, and wherein air regulated by the pressure regulating valve is introduced into the corresponding air motor to achieve regulation of a rotational speed and torque of the air motor, and the pressure regulating valve is in pneumatic communication with the air tank or the air compressor airway.

3. The system according to claim 2, wherein the system further comprises a controller, and the controller is in operable communication with the first distribution valve group, the air compressor, the pressure regulating valve, and the execution module.

4. The system according to claim 3, wherein the execution module comprises a manual execution unit, and the manual execution unit comprises at least one first executive mechanism, each first executive mechanism being in pneumatic communication with an air motor, and a control button, the control button being in operably communication with the controller.

5. The system according to claim 3, wherein the execution module comprises an automatic execution unit, and the automatic execution unit comprises at least one second executive mechanism, each second executive mechanism being in pneumatic communication with an air motor and in operable communication with a sensor, and wherein the sensor is in operable communication with the controller.

6. The system according to claim 3, wherein system comprises a single pressure regulating valve, wherein the first distribution valve group is successively in pneumatic communication with the pressure regulating valve and the second distribution valve group, and wherein air regulated by the pressure regulating valve is in pneumatic communication with a plurality of air motors through the second distribution valve group, the second distribution valve group being in operable communication with the controller.

7. The system according to claim 3, wherein the system comprises a plurality of pressure regulating valves, wherein each air motor is equipped with a pressure regulating valve to regulate an intake air pressure, and several of the pressure regulating valves are each in pneumatic communication with the first distribution valve group airway.

8. The system according to claim 1, wherein the execution module includes one of a seat adjustment mechanism, a window lifting mechanism, a sunroof opening and closing system, a trunk/tailgate opening and closing mechanism, a wiper mechanism, an air conditioning damper control, and a door lock mechanism.

9. The system according to claim 1, wherein the motor driving the compressed air of the air compressor is a brushless motor with stepless frequency control function.

10. The system according to claim 1, wherein the air usage module is an air spring.

11. A central air source for a vehicle system, the central air source comprising:
an air compressor;
an air tank; and
an air usage module,
wherein the central air source is configured to provide pressurized air to at least one actuator of the vehicle, and
wherein the air compressor is in operable communication with a controller, and wherein actuation of each of the at least one actuator is controlled by a control button, which control button is in operable communication with the controller.

12. The central air source of claim 11, wherein the at least one actuator comprises at least one of a window lifting mechanism, a trunk opening mechanism, a trunk closing mechanism, a seat adjustment mechanism, and a wiper mechanism.

13. The central air source of claim 11, wherein the central air source is configured to provide pressurized air to the at least one actuator by air compressed by the air compressor.

14. The central air source of claim 11, wherein the central air source is configured to provide pressurized air to the at least one actuator by compressed air stored in the air tank.

15. The central air source of claim 11, wherein at least one pressure regulating valve is in pneumatic communication and disposed between the central air source and the at least one actuator.

16. The central air source of claim 15, wherein the at least one actuator comprises a plurality of actuators.

17. The central air source of claim 16, wherein the at least one pressure regulating valve comprises a plurality of pressure regulating valves, and wherein each of the plurality of pressure regulating valves corresponds to one of the plurality of actuators.

18. The central air source of claim 15, wherein an air motor is in pneumatic communication with and disposed between each of the at least one actuator and each of the at least one pressure regulating valve.

19. The central air source of claim 11, wherein a motor used by the air compressor is a brushless motor.

20. The central air source of claim 11, wherein a motor used by the air compressor has a stepless frequency conversion control function.
